(19) United States
(12) Patent Application Publication
(10) Pub. No.: US 2013/0278218 A1
(43) Pub. Date: Oct. 24, 2013

(54) METHOD AND SYSTEM FOR BALANCING CELLS WITH VARIABLE BYPASS CURRENT

(71) Applicant: Boston-Power, Inc., Westborough, MA (US)

(72) Inventors: Per Onnerud, Framingham, MA (US); Chad Souza, North Providence, RI (US); Mark Gerlovin, Lexington, MA (US); Phillip E. Partin, Grafton, MA (US); Richard V. Chamberlain, II, Fairfax Station, VA (US); Eckart W. Jansen, Belmont, MA (US)

(21) Appl. No.: 13/790,588

(22) Filed: Mar. 8, 2013

Related U.S. Application Data
(60) Provisional application No. 61/611,802, filed on Mar. 16, 2012.

(51) Int. Cl. H02J 7/00

(52) U.S. Cl. CPC H02J 7/0063
USPC 320/118

(57) ABSTRACT

A circuit for balancing battery cells includes a plurality of resistors configured in parallel with the battery cells, and a plurality of switches configured in series with the resistors. A control circuit causes the switches to balance the battery cells based on detected voltage of the battery cells and based on past operation of the cells.

### RELATED APPLICATIONS

This application claims the benefit of U.S. Provisional Application No. 61/611,802, filed Mar. 16, 2012, the relevant teachings of which are incorporated herein by reference in their entirety.

### BACKGROUND OF THE INVENTION

The performance and lifetime of a battery pack is significantly affected by the way it is operated in the field, particularly in demanding applications such as operating electric vehicles. For example, some lithium ion cells connected in series in a battery pack charge and discharge faster than others in the battery pack. The lifetime of the pack degrades significantly if the voltage across one or more if its component cells falls outside a predetermined range (typically 3 volts to 4.20 volts) during discharging or charging. For this reason, battery management systems (BMS) typically are used to monitor cell voltages to maintain voltages in a particular range. The imbalance between cells limits the effective range of operation of the battery pack unless the charge in some cells is rebalanced during operation of the pack.

Several balancing techniques are known in the art, the most common of which is passive balancing during charging. The passive vs active nomenclature used here refers to the ability to store/recover energy that is removed from the cell during the balancing process. In a “passive” system, the energy of one cell is not transferred to another in order to balance the energy stored in the cells. Rather, the energy of one cell is simply dissipated as heat energy until the energy stored within it is about that of another cell with which it is being balanced. In contrast, an “active” balancing system transfers energy from one cell to another to balance the energy stored in those cells. For example, an inductive energy storage element can be employed to temporarily store energy before transferring it to one or more neighbor cells.

An example of a prior art passive balancing circuit is shown in FIG. 1. Here, during the charging process, the dissipative resistive element, R_{B}, is switched using balancing switch transistor, T_{SB}, across any cell that exceeds a predetermined voltage threshold to by-pass lower-capacity cells. In effect, charge current to lower-capacity cells is being reduced such that higher-capacity cells charge more fully. The resistance value of the R_{B} is typically determined at pack design time in passive balancing systems known to the art. The resistance is calculated by the pack designer to enable a single fixed-balance current level when T_{SB} is activated, acceptable for the nominal cell specification, and it is used for each cell during the entire lifetime of the pack from the first cycle to an end-of-life cycle.

However, as cells approach their end of life, they often require higher balancing currents to balance charge effectively. A single fixed resistance, while providing effective balancing capacity during a cell's early life, does not provide the needed balancing current at the end of the cell's life. Similarly, at the beginning of a cell's life, charge holding capacities of all the cells typically are at their most equivalent state. During this time, the use of larger-than-required balancing currents, as would be the case with a single fixed resistance for each cell, creates deleterious consequences. For example, increased thermal energy waste is generated by dissipation in balancing resistors, and unneeded additional cycling of the cells results in cell capacity degradation.

Another disadvantage of existing passive balancing techniques is that they treat all cells identically by applying the same balancing resistance to each cell. However, some cells degrade at a faster rate than others, as shown in FIG. 5, and as these cells are not provided with added balancing current capacity, they require longer overall pack-balancing times, thereby reducing performance. In addition, the remaining healthier cells are subject to higher than necessary balancing current, which causes increased capacity degradation.

### SUMMARY OF THE INVENTION

Embodiments of the invention relate to methods and systems for operating battery packs, and more particularly, to operating battery packs for enhanced performance and longevity through periodic automated selection and adjustment of cell balancing current values during use.

In one embodiment, a cell balancing circuit may include at least one resistor and at least one respective switch configured in parallel with a battery cell. A control circuit generates a pulse-width modulated (PWM) control signal to the switch. The duty cycle of the PWM control signal enables adjustment of the balancing current based on an indication of past operation of the battery cell. A control circuit enables the PWM control signal based on a detected voltage of the battery cell, to balance the battery cell. The control circuit controls the switch to partially discharge or reduce the charge current to the battery cell and thereby balance the cell relative to another cell with which the cell is connected in series. The duty cycle of the PWM control signal is selected corresponding to a selected balancing current based on an indication of past operation of the battery cell. The control circuit may also detect a predetermined cycle life of the battery cell, the control circuit selecting the balancing current based on this predetermined cycle life of the battery cell. The indication of past operation may include an indication of one or more of a cycle count, full charge capacity and state of health of the battery cell. The selection of the resistance value is made such that the maximum balancing current required at the end-of-life for the battery cell is achieved when the duty cycle of the PWM control signal is 100%. Further, each of the switches, or a particular combination of the switches, may correspond to different periods of a cycle life of the battery cell.

In one embodiment, a cell balancing circuit may include a plurality of resistors and respective switches configured in parallel with a battery cell. A control circuit enables at least one of the switches, based on a detected voltage of the battery cell, to balance the battery cell. The control circuit selects the switches to enable based on an indication of past operation of the battery cell. The indication of past operation may include an indication of one or more of a cycle count, full charge capacity and state of health of the battery cell. Further, each of the switches, or a particular combination of the switches, may correspond to different periods of a cycle life of the battery cell.

In further embodiments, a cell balancing circuit may include a variable resistor configured in parallel with a battery cell, along with a switch configured in series with the variable resistor. A control circuit enables the switch, based on a detected voltage of the battery cell, to balance the battery cell. Further, the control circuit controls the resistor value of the variable resistor based on an indication of past operation of the battery cell. The variable resistor may be a digital resistor circuit or an analog circuit.

The invention provides several advantages. For example, by providing a cell balancing circuit having an adjustable balancing current, embodiments of the invention can provide a balancing current for a respective cell that is best suited to the cell's properties or desired performance at any point in the life of the battery cell. By controlling the balancing current in response to the cell's properties, the cells of a battery can be balanced more efficiently at the early life stage of a battery, thereby reducing the energy typically wasted in balancing, as well as the reduced cycle life resulting from a higher-than-necessary balancing current. The cells can also be balanced more effectively at the end-of-life stage of a battery, by applying maximum available balancing current to ensure that each cell's excess energy is fully dissipated. Moreover, embodiments of the invention can provide an appropriate balancing current to each cell individually, accounting for different characteristics of each cell of a battery, and thereby provide an efficient and effective balancing current that is specific to the cell. Further, cells can be balanced based on a desired cycle lifetime, thereby ensuring that the battery performs through a minimum number of charges and discharges.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a circuit diagram of a prior art, passive balancing circuit.

FIGS. 2A-B are block diagrams of a battery system implementing embodiments of the invention.

FIG. 3 is a circuit diagram of a balancing circuit in one embodiment of the invention.

FIGS. 4A-B are circuit diagrams of balancing circuits in further embodiments of the invention.

FIG. 5 is a block diagram of a balancing circuit and BMS controller in a further embodiment of the invention.

FIG. 6 is a signal diagram illustrating operation of the balancing circuit as shown in FIG. 5.

FIG. 7 is a plot of battery storage capacity corresponding to operation of a balancing circuit in still another embodiment of the invention.

FIG. 8 is a plot illustrating variable stored charge among a plurality of different battery cells according to yet another embodiment of the invention.

FIGS. 9A-C are flow charts illustrating operation of a battery management system controller of the invention.

### DETAILED DESCRIPTION OF THE INVENTION

The invention includes a system, circuit and method for periodically selecting and adjusting cell balancing current during operation of the battery pack in a manner to control cell and cell-pack lifetime trends, thereby improving cell-pack performance and longevity. Cell balancing current can be adjusted by changing the effective resistance of the balancing circuit. Changing resistance of the balancing circuit of each cell during the operating lifetime of the cell-pack reduces overall balancing time, thereby increasing cell-pack performance. Balancing with different selected resistors while maintaining a fixed overall balancing time controls the lifetime capacity degradation in cells, further increasing overall pack cycle life.

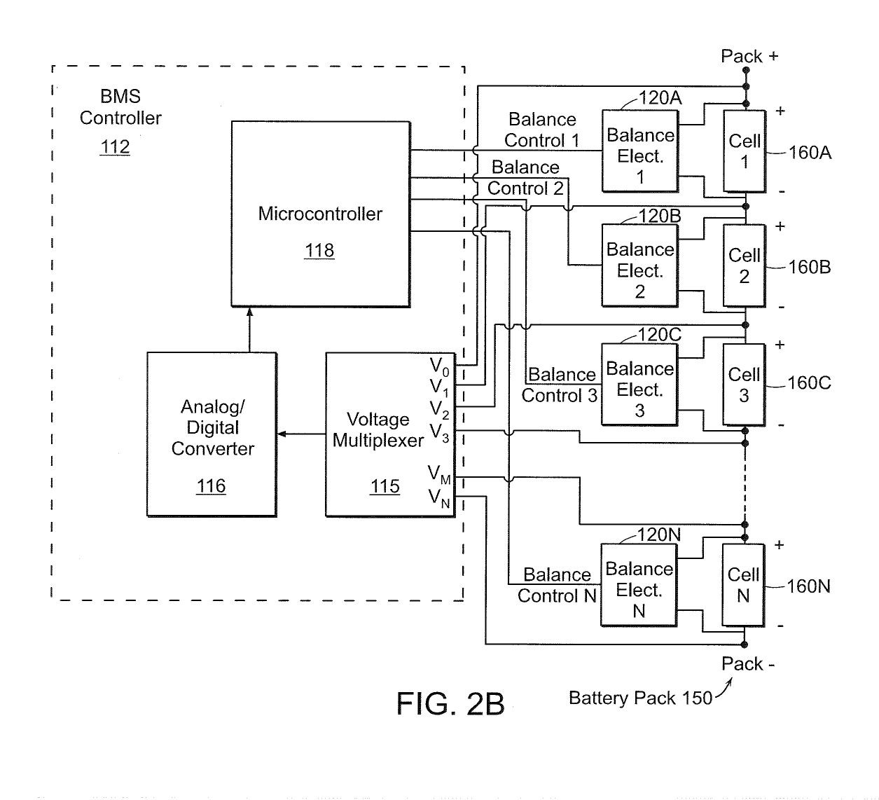

FIG. 2A is a block diagram of a battery system 100 employing an embodiment of the invention. A battery pack 150 comprises a number of cells, which may be arranged in a series or parallel configuration, or a combination thereof, or may be configured hierarchically in one or more battery modules. A voltage monitor 130 detects the voltage at the cells and/or modules, and forwards this information to the battery management system (BMS) controller 110. Voltage monitor 130 collectively represents voltage multiplexor 115 and Analogue/Digital converter 116 shown in FIG. 2B. BMS controller 110 is equivalent to microcontroller 118 of FIG. 2B. Based on the voltage data, as well as information about the battery cells, the BMS controller 110 provides balancing control signals to the balancing electronics 120. The balancing electronics 120, responsive to the control signals, perform balancing operations at one or more of the cells. Battery pack 150 and balancing electronics 120 together represent an embodiment of the invention shown in FIG. 2B.

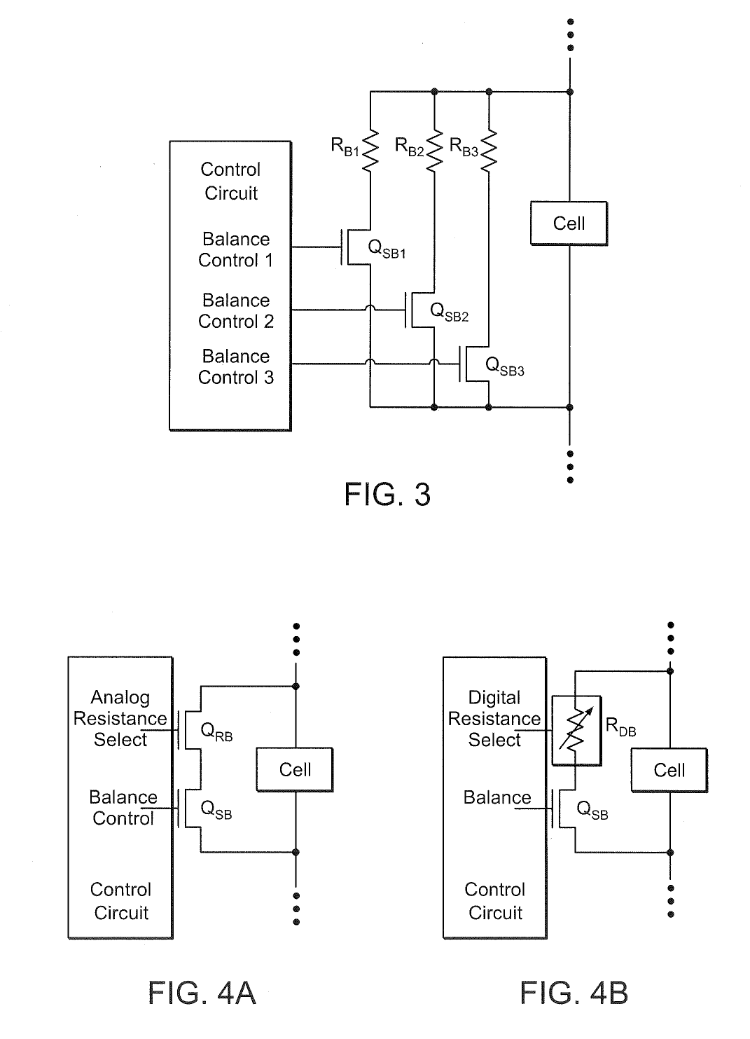

FIG. 2B is a block diagram of a battery system 101, comparable to the battery system 100 of FIG. 2A, showing a circuit configuration in further detail. A plurality of balancing circuits 120A-N are each connected in parallel with a respective battery cell 160A-N of a battery pack 150. Voltage monitoring circuitry is incorporated in the BMS controller 112, and includes a voltage multiplexor 115 to receive an indication of voltage levels at each of the nodes between the battery cells 160A-N. An analog-to-digital converter 116 converts the received voltage signals to data usable by the BMS microcontroller 118 for determining the voltage level at each of the battery cells 160A-N. Based on the voltage data, as well as information about the battery cells, the BMS controller 112 provides balancing control signals (“Balance Control 1” . . . “Balance Control N”) to the balancing electronics 120A-N. Multiple cells may be balanced simultaneously when the BMS controller activates more than one balance control signal. For example, if three cells in the pack are measured to be overcharged, the balancing controller could activate their three corresponding balancing control signals, thereby causing the three cells to discharge at the same time. Operation of the BMS controller 112, as well as configuration and operation of the balancing circuits 120A-N, is described below with reference to FIGS. 3-7.

FIG. 3 is a circuit diagram of a balancing circuit in one embodiment of the invention. Here, multiple discrete resistors R_{B1}, R_{B2}, R_{B3} are connected in parallel with a given cell under control of respective balancing control signals and switching transistors Q_{SB1}, Q_{SB2}, Q_{SB3} driven by a control circuit (e.g., the BMS controller, FIG. 3). Different resistance values may be switched into a given cell depending on balancing requirements for that cell.

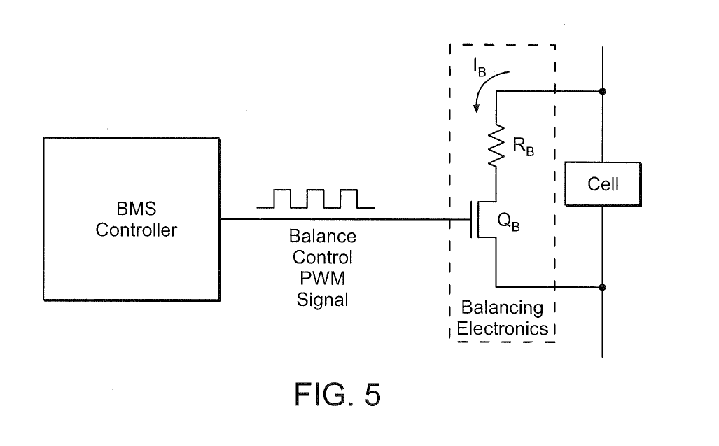

FIGS. 4A-B are circuit diagrams of balancing circuits in further embodiments of the invention. In both circuits, a variable resistor component (Q_{RB} and R_{DB}, respectively) is switched (via switch transistor Q_{SB}) in parallel with a given cell under control of a balancing control signal and a resistance level signal driven a control circuit (e.g., the BMS controller, FIG. 3). The balancing circuit shown in FIG. 4A includes an analog controlled resistor component Q_{RB}. The resistor component Q_{RB} may include, for example, a MOSFET transistor biased in a manner such that analog variations in gate voltage produce approximately linear variations in channel resistance to serve as the balancing resistance. The balancing circuit shown in FIG. 4B includes a digitally-controlled resistance circuit R_{DB}, which can be used to control variable resistance with digital control signals driven by the BMS controller. An example of a digitally-controlled resistance circuit is the AD5174 Digital Potentiometer, commercially available from Analog Devices™. In contrast to the selection of one of a plurality of discrete resistors as provided in the embodiment of FIG. 3, both of the balancing circuits of FIGS. 4A-B enable the selection of a range of resistor values according to a control signal provided by a BMS controller.

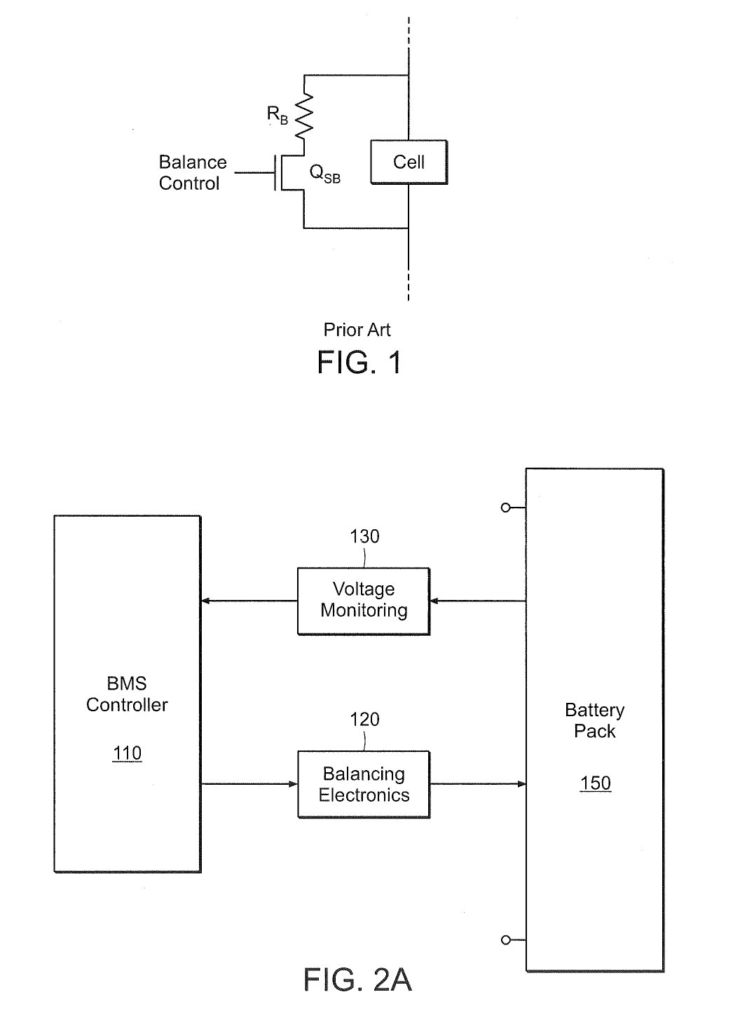

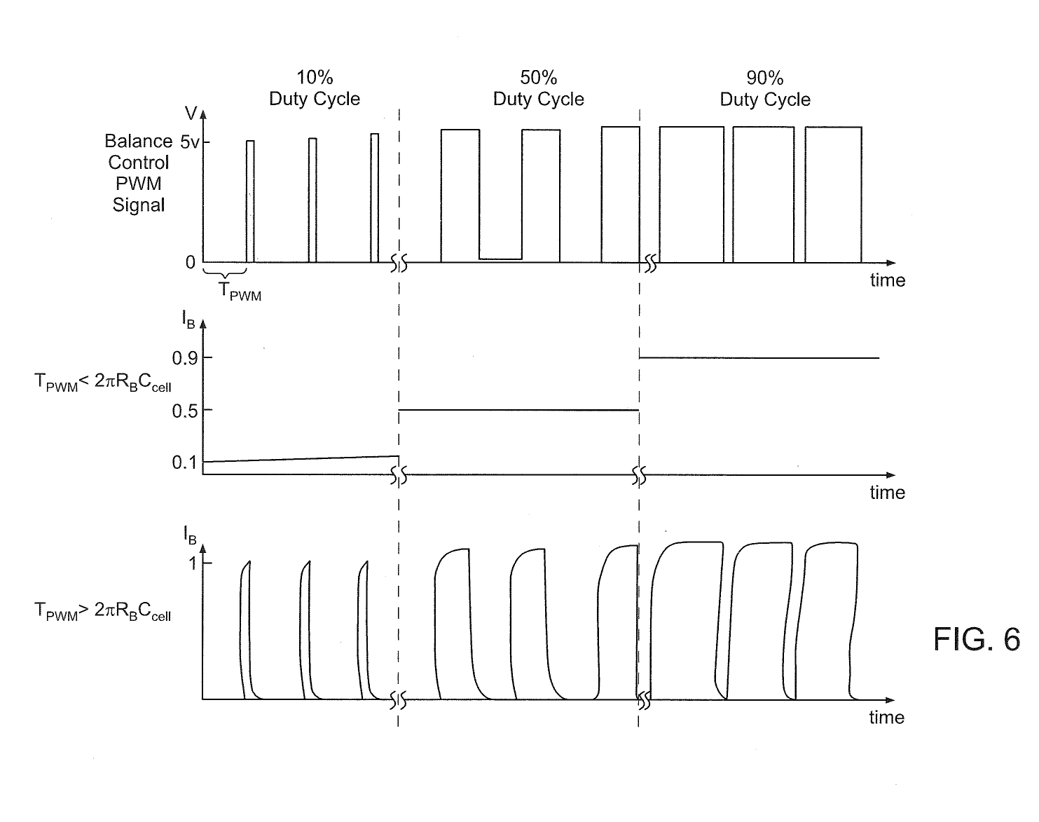

FIG. 5 is a block diagram of a balancing circuit and BMS controller in a further embodiment of the invention. Here, the balancing circuit includes a resistor R_{B} having a fixed value and a transistor Q_{B} configured in parallel to a cell. The transistor Q_{B} receives a balance control signal from a BMS controller. The balance control signal controlling the transistor Q_{B} is a pulse-width modulated (PWM) digital signal. At certain PWM frequency ranges with a time constant much smaller than the balancing time interval, the PWM signal varies the time average balancing current during the balancing time interval. As a result, the balancing circuit can generate a balancing current I_{B} that varies according to the duty cycle of the balance control signal. PWM control can be implemented in circuit configurations represented in FIGS. 1, 2A-B, 3, 4A and 4B as a drive for the balancing switch transistor Q_{SB} to control the time-average balancing current. In still further embodiments, PWM control may be implemented in balancing circuits having multiple selectable resistors, such as the embodiment described above with reference to FIG. 3, in order to provide a variable balancing current I_{B} in addition to the multiple, fixed balancing currents available without PWM control.

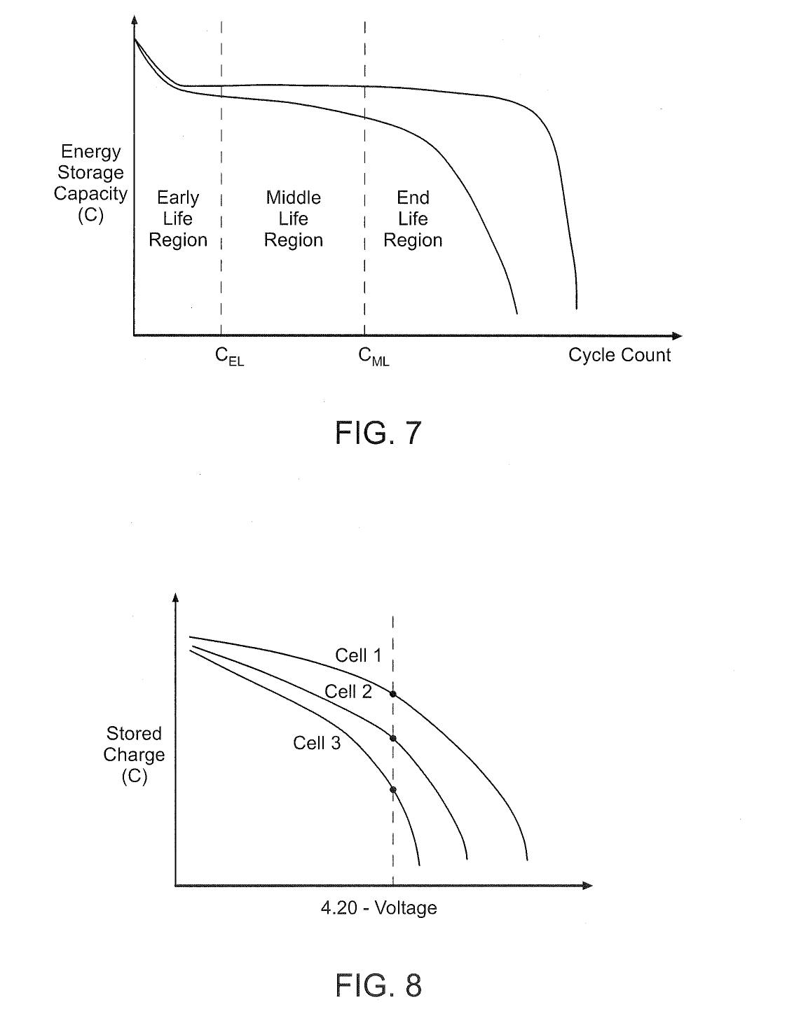

FIG. 6 is a signal diagram illustrating operation of the balancing circuit as shown in FIG. 5 according to one embodiment of the invention. The signal diagram includes the PWM balance control signal during duty cycles of 10% (first column), 50% (second column) and 90% (third column), and the corresponding balancing current I_{B} at each duty cycle. The topmost row shows the PWM control signal applied to the switch Q_{B} (FIG. 5). The capacitance of the battery cell (C_{cell}) and the balancing circuit DC resistance (R_{B}) form a 1^{st} order low-pass filter. The minimum duty cycle Dₘᵢₙ used to select the minimum balancing current allowed before the balancing circuit is disabled must be specified by the pack designer, then the minimum frequency fₘᵢₙ can be calculated as follows:

$${f}_{min} = \frac{1}{{D}_{min} 2 π {R}_{B} {C}_{cell}} \qquad ( EQ 1 )$$

In order to reduce switching noise it is desirable to select a minimum PWM frequency and duty cycle which results in a continuous balancing current as shown in the middle row of FIG. 6. If the PWM frequency or duty cycle is too low the balancing current will oscillate as shown in the bottom row of FIG. 6 generating significant switching noise. The duty cycle of the PWM balance control signal is varied by increasing or decreasing the “ON” time of the signal. A lower duty cycle results in a lower average current (I_{B}) while a higher duty cycle results in a higher I_{B}, also shown in FIG. 6. The equation for selecting a duty cycle based on desired balancing current I_{B}, the voltage of the battery cell V_{cell} and the balancing circuit resistance R_{B} is as follows:

$$Duty Cycle = 100 \times {I}_{B} \times \frac{{R}_{B}}{{V}_{cell}} \% , where {I}_{B} must be < \frac{{V}_{cell}}{{R}_{B}} \qquad ( EQ 2 )$$

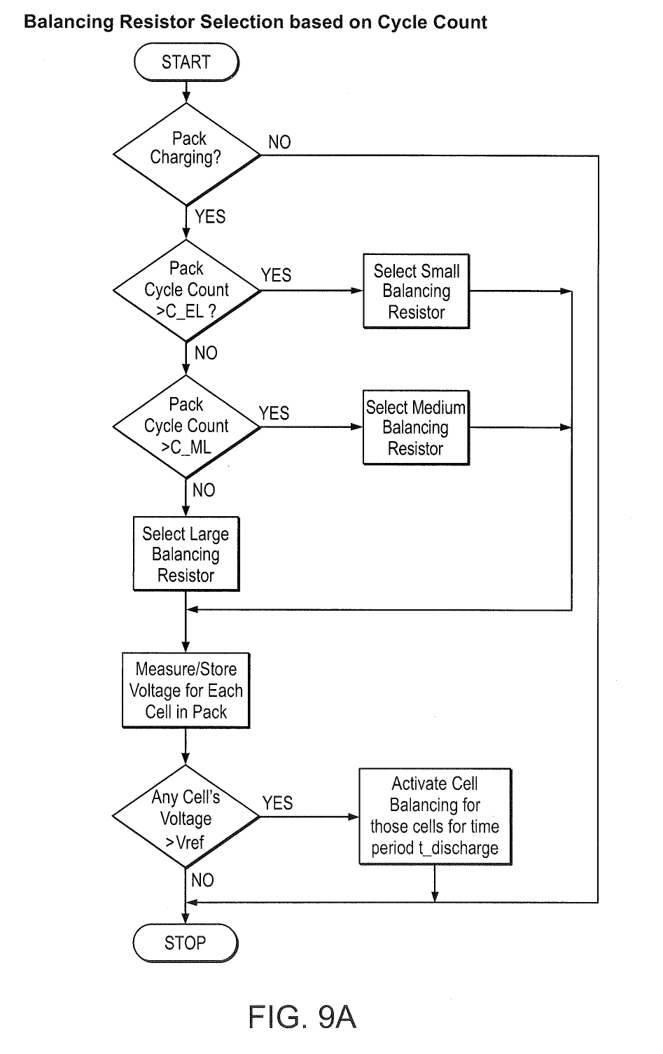

FIG. 7 is a plot of battery storage capacity (C) over the life (cycle count) of a battery. As illustrated by the distinct plotted lines, storage capacity over the cycle life can differ among battery cells, indicating different rates of cell degradation. Embodiments of the invention may employ a BMS controller (e.g., controllers 110 and 112 in FIGS. 2A-B) configured to control a plurality of balancing circuits (e.g., balancing circuits in FIGS. 3-4B), to select the resistor value of the balancing circuit based on the detected cycle life region of the battery cell. Cycle life regions are determined by cycle count number and, for example, can divide the operating life of a battery pack into three regions: “early-life,” “middle-life,” and “end-of-life.” In one embodiment, using a balancing circuit as shown in FIG. 3, resistor values are R_{B1}>R_{B2}>R_{B3}. During the early life region, balancing resistor R_{B1} is selected to apply a low balancing current to all cells. During the middle life region, balancing resistor R_{B2} is selected to apply a mid-level balancing current, and during end-of-life, balancing resistor R_{B3} is selected to provide a high level of balancing current. One benefit of this approach is that, as cell capacities degrade through cycle lifetime, resistor values corresponding to the detected age of the cell is used to balance the cell, thereby effectively and optimally balancing the battery cells.

In a further embodiment, the BMS controller may select the resistor value of the balancing circuit based on a desired lifetime performance trend shape. High balancing current is not desirable in a passive balancing system because it generates heat and heat can damage the cells (accelerated loss of capacity). Therefore it is desirable to use the smallest effective balancing current in order to maintain a balanced pack and get the longest possible lifetime performance. So, when the pack is new the balancing current should be low because minimal balancing is needed and the lower balancing current will result in less heat. As the pack ages the balancing current should be increased in order to maintain the same balancing time (performance). Accordingly, design of the pack should include consideration of the maximum balancing current that is needed at the end-of-life to maintain the desired balancing time and the resistor should be selected accordingly. The trade-off is that a higher maximum current is more expensive, so if the cycle life and/or pulse power requirements are less, then cost can be reduced by reducing the maximum balancing current. This life performance trend shaping approach is useful in cases such as where a service warrantee is in effect over a pre-defined time period to insure that capacity degradation due to the balancing system is limited sufficiently to enable the pack to meet its warranty period service requirements. Manufacturers will be enabled to determine warranty periods more accurately based on statistical lifetime of, for example, 95% of its cells. The benefit is greater predictability and reduced warranty service expense to the manufacturer.

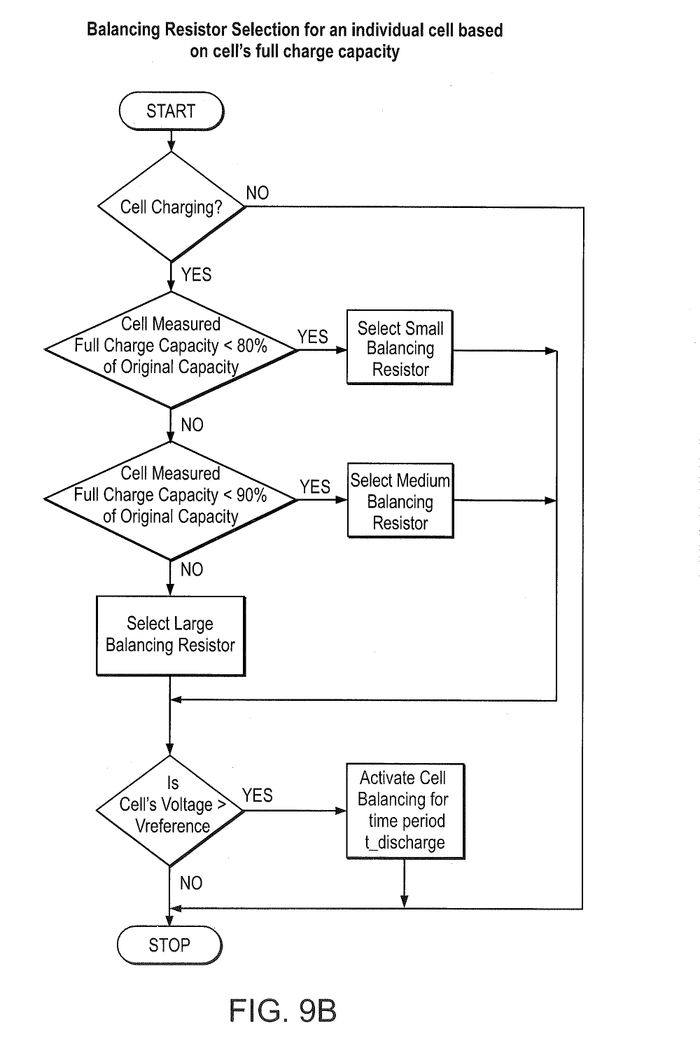

FIG. 8 is a plot illustrating variable stored charge (C) among multiple different battery cells. In another embodiment, the multiple discrete resistor value or particular variable resistance setting is selected depending on the in-use requirements of individual cells, such as the different stored charges as shown in FIG. 8. As cells exhibit different charge capacities, some weaker and some stronger, the BMS controller selects correspondingly effective and optimal balancing resistance values on a cell-by-cell basis. The advantage of this approach is that different balancing current levels may be provided to each cell as needed, thereby improving balancing performance and overall cycle lifetime.

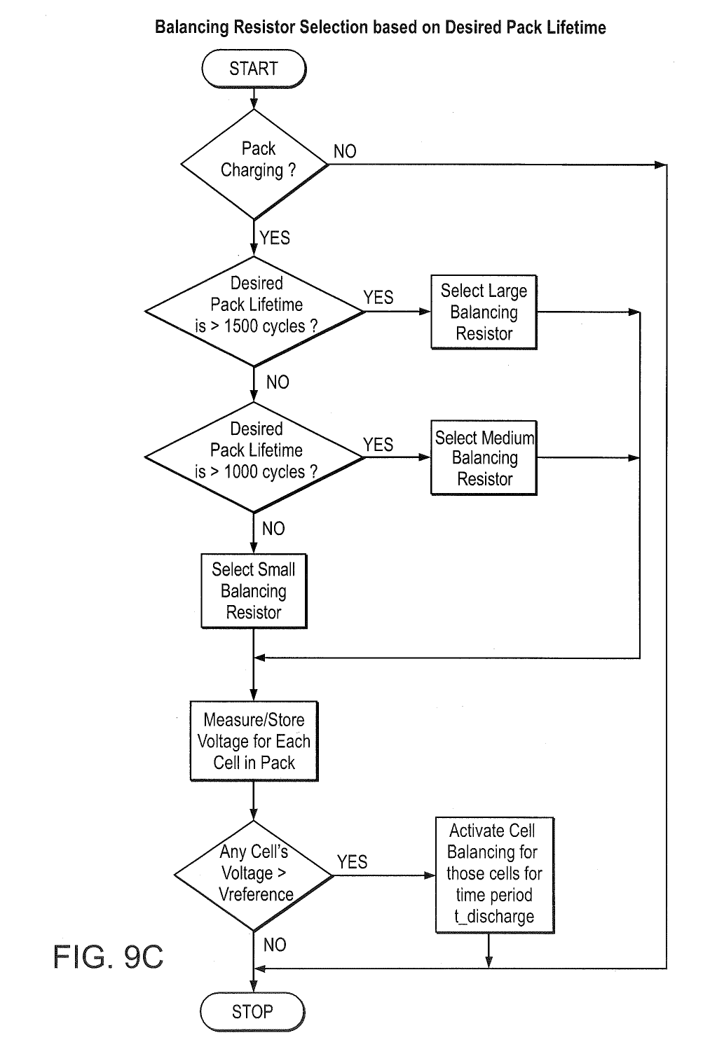

FIGS. 9A-C are flow charts illustrating operation of a BMS controller. In each embodiment, the BMS controller determines the balancing current I_{B} to be generated for a particular cell, and the balancing current I_{B} in turn corresponds to a particular resistor value that may be selected for generating the balancing current I_{B}. As a result, the proper resistor or resistor value is selected at a balancing circuit, such as the balancing circuits shown in FIGS. 3 and 4A-B, for balancing the respective cell. In further embodiments, PWM control, as described above with reference to FIGS. 5 and 6, may be used to generate a balancing current I_{B} that is equivalent to the current that would be generated through the selected balancing resistor.

FIGS. 9A-C each provide for resistor selection based on a particular detected value, including the cycle count (number of charges and discharges) of a battery, the full charge capacity of a battery, and desired pack lifetime. Although each of the processes described below, with reference to FIGS. 9A-C, employs a single detected value, embodiments of the invention may employ multiple detected values to determine the proper balancing resistor, and may employ steps from one or more of the processes shown in FIGS. 9A-C. Further, these processes may be adapted to implement the PWM control. In particular, a PWM signal may be used to generate a balancing current I_{B} that is equivalent to the current that would be generated through the selected balancing resistor. To minimize the heat generated by the balancing resistors during each charge cycle the balancing current for each battery cell in the system should be selected such that it is as low as possible without extending the required balancing time for the pack. To achieve this, the balancing current for each cell must be selected such that all cells complete balancing at the same time. A particular cell only requires balancing if its capacity is less than the greatest cell capacity within the pack. For each cycle, the capacity of each cell is calculated by the microcontroller 118. The selected balancing current I_{B} for each cell will then be inversely proportional to the cells' calculated capacity C_{calc} such that the cell with the lowest capacity Cₘᵢₙ will use the maximum balancing current and the cell with the highest capacity Cₘₐₓ will have zero balancing current.

$${I}_{B} = \frac{{V}_{cell}}{{R}_{B}} \times \frac{{C}_{max} - {C}_{calc}}{{C}_{max} - {C}_{min}} \qquad ( EQ 3 )$$

The equation above is then used to simplify the calculation of PWM duty cycle for each cell using EQ 2 as follows:

$$Duty Cycle = 100 \times \frac{{C}_{max} - {C}_{calc}}{{C}_{max} - {C}_{min}} \% \qquad ( EQ 4 )$$

FIG. 9A illustrates a process of selecting a balancing resistor based on cycle count of the battery. Provided that the battery pack to which the battery cell belongs is charging, the present cycle count of the battery cell is compared against a first threshold C_EL indicating an end-of-life region of the battery. The present cycle count may be a value, stored at the BMS or other device, that is incremented in response to each cycle of charging and discharging of the battery cell. If the end-of-life threshold is met, then a smaller balancing resistance is selected. Otherwise, the present cycle count is compared against a threshold C_ML indicating a middle-life region of the battery. If the middle-life threshold is met, then a balancing resistor is selected that is between the smaller and larger resistances employed for end-of-life or early life of the battery. Otherwise, the battery cell is determined to have a cycle count in an early-life region, and a larger balancing resistance is selected. This process may be completed in parallel or sequentially for each of the battery cells in the battery pack.

Once the resistor value is selected, the voltage of each battery cell in the battery pack is measured and stored. If any of the battery cells are detected to have a voltage above a reference voltage threshold V_{REF}, then a respective balancing circuit is activated, employing the selected resistor, to lower the cell voltage to an acceptable value.

FIG. 9B illustrates a process of selecting a balancing resistor based on a battery cell's full charge capacity. Provided that the battery pack to which the battery cell belongs is charging, the measured full-charge capacity of the battery cell is compared against a first threshold (e.g., less than 80%) indicating an end-of-life region of the battery. The full-charge capacity may be a value, stored at the BMS or other device, that is measured periodically by measuring the voltage of the battery at full charge, thereby indicating the present full-charge capacity of the battery cell. If the end-of-life threshold is met, then a smaller balancing resistance is selected. Otherwise, the present cycle count is compared against a second threshold (e.g., less than 90%) indicating a middle-life region of the battery. If the middle-life threshold is met, then a medium balancing resistance is selected that is between the smaller and larger resistances. If the battery cell is determined to have a cycle count in an early-life region, a large balancing resistance is selected. This process may be completed in parallel or sequentially for each of the battery cells in the battery pack.

Once the resistor value is selected, the voltage of each battery cell in the battery pack is measured and stored. If any of the battery cells are detected to have a voltage above a reference voltage threshold V_{REF}, then a respective balancing circuit is activated, employing the selected resistor, to lower the cell voltage to an acceptable value.

FIG. 9C illustrates a process of selecting a balancing resistor based on a desired cycle lifetime of the battery pack. Provided that the battery pack to which the battery cell belongs is charging, the desired cycle lifetime (a value of a number of charge/discharge cycles) is compared against a first threshold (e.g., 1500 cycles). The desired cycle life may be a predetermined value, stored at the BMS or other device, that indicates the number of charging cycles that the battery pack is desired to complete with an acceptable charge capacity. If the first threshold is met, then a smaller balancing resistance is selected. Otherwise, the desired cycle lifetime is compared against a second threshold (e.g., 1000 cycles). If the second threshold is met, then a balancing resistance is selected that is between the smaller and larger resistances. Otherwise, a large balancing resistor is selected. This process may be completed in parallel or sequentially for each of the battery cells in the battery pack.

Once the resistor value is selected, the voltage of each battery cell in the battery pack is measured and stored. If any of the battery cells are detected to have a voltage above a reference voltage threshold V_{REF}, then a respective balancing circuit is activated, employing the selected resistor, to lower the cell voltage to an acceptable value.

While this invention has been particularly shown and described with references to example embodiments thereof, it will be understood by those skilled in the art that various changes in form and details may be made therein without departing from the scope of the invention encompassed by the appended claims.

What is claimed is:

1. A system for balancing a plurality of battery cells, comprising:
a) a plurality of battery cells connected in series, at least one of the battery cells including
i) a resistor component configured in parallel with a battery cell, and
ii) a switch configured in series with the resistor component; and
b) a control circuit configured to cause the switch, based on a detected voltage of the battery cell, to partially discharge the battery cell and thereby balance the cell relative to another cell with which the cell is connected in series, the control circuit generating a pulse-width modulated (PWM) signal, corresponding to a selected balancing current, to the switch.

2. The system of claim 1, wherein the control circuit further detects a predetermined cycle life of the battery cell, and wherein the control circuit selects the balancing current based on the detected predetermined cycle life of the battery cell.

3. The system of claim 1, wherein the control circuit is configured to select the balancing current based on an indication of past operation of the battery cell.

4. The system of claim 3, wherein the indication of past operation corresponds to cycle count of the battery.

5. The system of claim 3, wherein the indication of past operation is an indication of one or more of a cycle count, full charge capacity and state of health of the battery cell.

6. The system of claim 3, wherein the indication of past operation corresponds to a calculated capacity of the battery cell relative to a range of calculated cell capacities of the plurality of battery cells.

7. The system of claim 6, wherein the control circuit selects the balancing current to minimize heat generation within the plurality of battery cells without extending a period of time required to balance the plurality of battery cells.

8. The system of claim 1, wherein a minimum frequency and duty cycle of the PWM control signal are selected to minimize switching noise generated by the control circuit.

9. A method of balancing a plurality of battery cells, comprising the steps of:
a) monitoring a voltage across a battery cell;
b) selecting a balancing current; and
c) generating a pulse-width modulated (PWM) signal to a switch configured in parallel to the battery cell to partially discharge the battery cell and thereby balance the battery cell relative to another battery cell with which the cell is connected in series, the PWM signal corresponding to the selected balancing current.

10. The method of claim 9, further comprising detecting a predetermined cycle life of the battery cell, the balancing current being selected based on the detected predetermined cycle life of the battery cell.

11. The method of claim 9, further comprising detecting an indication of past operation of the battery cell, the balancing current being selected based on the indication.

12. The method of claim 11, wherein the indication of past operation corresponds to cycle count of the battery.

13. The method of claim 11, wherein the indication of past operation is an indication of one or more of a cycle count, full charge capacity and state of health of the battery cell.

14. The method of claim 11, wherein the indication of past operation corresponds to a calculated capacity of the battery cell relative to a range of calculated cell capacities of the plurality of battery cells.

15. The method of claim 14, further comprising selecting the balancing current to minimize heat generation within the plurality of battery cells without extending a period of time required to balance the plurality of battery cells.

16. The method of claim 9, further comprising selecting a minimum frequency and duty cycle of the PWM control signal to minimize switching noise.

17. A system for balancing a plurality of battery cells, comprising:
a) a plurality of battery cells connected in series, at least one of the battery cells including:
i) a plurality of resistor components configured in parallel with a battery cell, the plurality of resistor components providing plural selectable resistances;
ii) plurality of switches, each of the plurality of switches configured in series with one of the plurality of resistor components; and
b) a control circuit configured to cause at least one of the plurality of switches, based on a detected voltage of the battery cell, to partially discharge the battery cell and thereby balance the cell relative to another cell with which the cell is connected in series, the control circuit selecting the at least one of the plurality of switches to generate a balancing current corresponding to a selected balancing current.

18. The system of claim 17, wherein the control circuit further detects a predetermined cycle life of the battery cell, and wherein the control circuit selects the balancing current based on the detected predetermined cycle life of the battery cell.

19. The system of claim 17, wherein the control circuit is configured to select the balancing current based on an indication of past operation of the battery cell.

20. The system of claim 19, wherein the indication of past operation corresponds to cycle count of the battery.

21. The system of claim 19, wherein the indication of past operation is an indication of one or more of a cycle count, full charge capacity and state of health of the battery cell.

22. The system of claim 19, wherein the indication of past operation corresponds to a calculated capacity of the battery cell relative to a range of calculated cell capacities of the plurality of battery cells.

23. The system of claim 22, wherein the control circuit selects the balancing current to minimize heat generation within the plurality of battery cells without extending a period of time required to balance the plurality of battery cells.

24. A system for balancing a plurality of battery cells, comprising:
a) a plurality of battery cells connected in series, at least one of the battery cells including:
i) a variable resistor component configured in parallel with a battery cell, the variable resistor component providing plural selectable resistances;
ii) a switch configured in series with the variable resistor component; and
b) a control circuit configured to cause the switch, based on a detected voltage of the battery cell, to partially discharge the battery cell and thereby balance the cell relative to another cell with which the cell is connected in series, the control circuit selecting a resistor value of the variable resistor to generate a balancing current corresponding to a selected balancing current.

25. The system of claim 24, wherein the control circuit further detects a predetermined cycle life of the battery cell, and wherein the control circuit selects the balancing current based on the detected predetermined cycle life of the battery cell.

26. The system of claim 24, wherein the control circuit is configured to select the balancing current based on an indication of past operation of the battery cell.

27. The system of claim 26, wherein the indication of past operation corresponds to cycle count of the battery cell.

28. The system of claim 26, wherein the indication of past operation is an indication of one or more of a cycle count, full charge capacity and state of health of the battery cell.

29. The system of claim 26, wherein the indication of past operation corresponds to a calculated capacity of the battery cell relative to a range of calculated cell capacities of the plurality of battery cells.

30. The system of claim 29, wherein the control circuit selects the balancing current to minimize heat generation within the plurality of battery cells without extending a period of time required to balance the plurality of battery cells.

31. The circuit of claim 24, wherein the variable resistor includes an analog resistor value control input.

32. The circuit of claim 24, wherein the variable resistor includes a digital resistor value control input.
